(19) United States
(12) Patent Application Publication
(10) Pub. No.: US 2007/0164930 A1
(43) Pub. Date: Jul. 19, 2007

(54) LED driving device with pulse width modulation

(75) Inventors: Yang-Chi Jeng, Hsin-chu City (TW); Rong-Tsung Lin, Hsin-chu City (TW)

Correspondence Address: CROCKETT & CROCKETT, 24012 CALLE DE LA PLATA, SUITE 400, LAGUNA HILLS, CA, 92653, US

(73) Assignee: Macroblock, Inc.

(21) Appl. No.: 11/430,673

(22) Filed: May 8, 2006

(30) Foreign Application Priority Data
Jan. 19, 2006 (TW) 95101997

(51) Int. Cl. G09G 3/14

(52) U.S. Cl. 345/39

(57) ABSTRACT

The present invention discloses an LED driving device with pulse width modulation (PWM) capable of preventing the LED display from flickering. The LED driving device primarily comprises a PWM unit for modulating the ON/OFF signal with a PWM cycle from one signal of higher resolution to two or more signals of lower resolution. The modulation is executed with the proviso that the duty cycle of the PWM cycle is almost or completely preserved. Accordingly, the LED will be lit more frequently and perform preset brightness with a higher refresh rate.

This application claims priority to Taiwan Patent Application 95101997 filed Jan. 19, 2006.

### BACKGROUND OF THE INVENTION

1. Field of the Invention

The present invention relates to a LED driving device with pulse width modulation (PWM).

2. Related Prior Art

In general, brightness of an LED can be varied with the duty cycle of a control signal delivered from a driving IC (integrated circuit) device. When the LED is desired to perform lower brightness with a shorter duty cycle, an external control system will output a signal with longer continuous “OFF” to the driving IC device, so that the LED is not lit or remains unilluminated for a longer time. In such situation, the LED display will flicker and show poor quality as it is perceived by viewers. FIG. 1 compares the images without and with flickering.

To prevent the LED display from flickering, the present invention provides a solution by dividing a continuous “ON” signal into many discrete “ON” signals and distributing them uniformly.

### SUMMARY OF THE INVENTION

The object of the present invention is to provide an LED driving device with pulse width modulation (PWM), which can effectively prevent the image from flickering.

To achieve the above object, the LED driving device with PWM primarily comprises a PWM unit and LED driving circuits. The LED driving device receives a preset value about brightness of the LED and delivers the preset value to the PWM unit. The PWM unit generates an ON/OFF signal with a duty cycle in a PWM cycle corresponding to the preset value and then modulates the ON/OFF signal. The modulated signal is output to the LED through the LED driving circuit to achieve a desired brightness. The PWM unit modulates the ON/OFF signal from one signal of higher gray-scale resolution to two or more signals of relatively lower gray-scale resolution, so that the LED will be lit more frequently with a higher refresh rate and brightness of the LED before and after modulation is exactly the same or similar to a viewer. Preferably, the duty cycle of the ON/OFF signal is preserved before and after modulation.

The PWM cycle of the ON/OFF signal has a continuous “ON” duration composed of a major “ON” cycle and a minor “ON” cycle. The PWM unit modulates the ON/OFF signal by dividing the major “ON” cycle into two or more parts each defined as a major “ON” sub-cycle, and distributing the major “ON” sub-cycles in the PWM cycle according to an algorithm.

The minor “ON” cycle may be ignored or further divided by the PWM unit into two or more parts each defined as a minor “ON” sub-cycle all of which are then distributed with the major “ON” sub-cycles. Preferably, the major “ON” cycle is evenly divided and uniformly distributed. The modulated signal output from the PWM unit is normally clock-based.

In the specification, terms are defined as follows:
1. Pulse width modulation (PWM) cycle, being the time for completely performing a control signal about LED brightness.
2. Duty cycle, being a percentage of time for “ON” with respective to a period of the PWM cycle.
3. Refresh rate, being a frequency for lighting the LED.
4. Gray-scale resolution, being the scales of brightness which the LED possibly performs.

### BRIEF DESCRIPTION OF THE DRAWINGS

FIG. 1 compares the images without and with flickering.

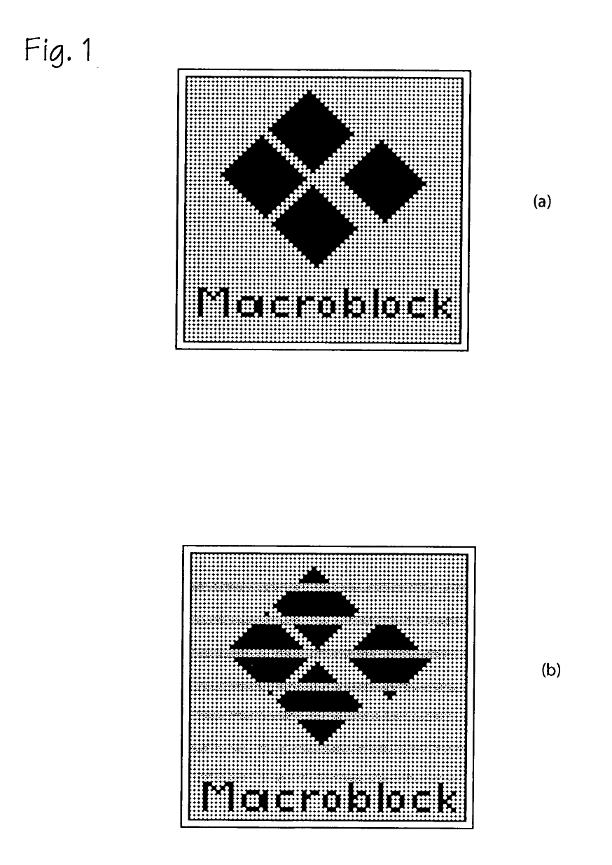

FIG. 2 schematically illustrates clock diagrams of the control signal divided in accordance with different algorithms.

### DETAILED DESCRIPTION OF THE PREFERRED EMBODIMENTS

To describe this invention more in detail, embodiments of algorithms for the PWM unit to modulate a signal are exemplified on the basis of the description in summary of the invention.

Note that the algorithms are not restricted and depend on developed computing techniques or technologies.

Also note that “the duty cycle is preserved” in the invention doesn't indicate “the duty cycle is kept absolutely the same”, but indicate no obvious difference for viewers. For example, the minor “ON” cycle could be ignored when being much less than the major “ON” cycle.

In the following algorithms, variables n, m, k, M, A, B, i are defined as follows:
n is a positive integer,
m is 0 or a positive integer less than n,
k is 0 or a positive integer less than m,
M is a positive integer less than 2ⁿ,
A is 0 or a positive integer less than M,
B is 0 or a positive integer less than 2^{k}×2^{n-m-k}, and
i is 0 or a positive integer equal to or less than 2^{k}.

In a preferred embodiment, the PWM unit employs formulae (I) and (I−1) to divide a PWM cycle having 2ⁿ clocks as follows:

$$\begin{matrix}{2}^{n} = [ ( {2}^{m} - 1 ) \times {2}^{k} ] \times {2}^{n - m - k} + [ {2}^{k} \times {2}^{n - m - k} ] \times 1 & ( I ) \\ = [ {2}^{m} \times {2}^{k} ] \times {2}^{n - m - k} & ( I \text{-} 1 )\end{matrix}$$

According to the above algorithms, the PWM cycle will be divided into:
a. (2^{n-m-k}+1) sub-cycles composed of 2^{n-m-k} sub-cycles each having (2^{m}−1)×2^{k} clocks, and one sub-cycle having 2^{k}×2^{n-m-k} clocks, as represented by formula (I); or
b. 2^{n-m-k} sub-cycles each having 2^{m}×2^{k} clocks, as represented by formula (I−1). For the both algorithms, 2^{k} is the frequency division factor applied to less division.

Also, in the preferred embodiment of the present invention, the PWM unit employs formulae (II) and (II−1) to divide the time for “ON” having M clocks in the PWM cycle as follows:

$$\begin{matrix}M = [ A \times {2}^{k} ] \times {2}^{n - m - k} + B \times 1 & ( II ) \\ = [ A \times {2}^{k} + i ] \times {2}^{n - m - k} & ( II \text{-} 1 )\end{matrix}$$

According to the above algorithms, the M clocks will be divided into:
a. (2^{n-m-k}+1) sub-cycles composed of 2^{n-m-k} sub-cycles each having A×2^{k} clocks and one sub-cycles having B clocks, as represented by formula (II); or
b. 2^{n-m-k} sub-cycles each having (A×2^{k}+i) clocks, wherein a sum of i from each sub-cycle is equal to B.

With respect to the formulae (I) and (II), each of the sub-cycles having (2^{m}−1)×2^{k} clocks may comprise A×2^{k} clocks for “ON”, and one sub-cycle having 2^{k}×2^{n-m-k} clocks may comprise B clocks for “ON”.

With respective to formulae (I-1) and (II-1), each of the sub-cycles having 2^{m}×2^{k} clocks may comprise (A×2^{k}+i) clocks for “ON”.

As a result, the LED display can exhibit an image with desired brightness and without flickering as the duty cycle is preserved and the refresh rate is increased. Also note that specific limitation to n or M is not necessary and depends on developments of photo-electric technologies.

In an actual design, a 16-bit counter in the PWM unit is provided for a PWM cycle and thus may perform a resolution of 65,536 (=2¹⁶) gray-scales. When the PWM cycle is divided into, for example, 64 (=2⁶) sub-cycles, the resolution will be reduced to 1,024 (=2¹⁰) gray-scales with a refresh rate 64.

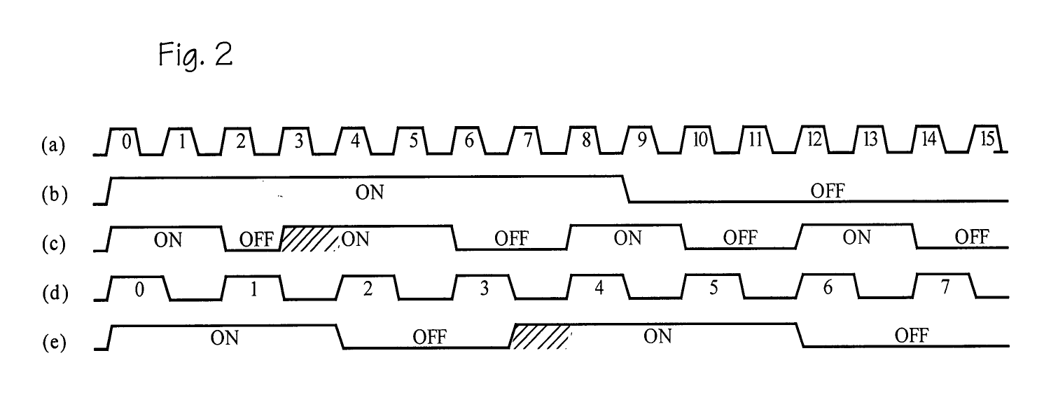

To illustrate the algorithms, schematically clock diagrams are shown in FIG. 2. Diagram (a) indicates 16 reference clocks. Diagram (b) indicates an undivided PWM cycle composed of nine continuous “ON” clocks and seven continuous “OFF” clocks. That is, the duty cycle is 9/16. Examples (A) and (B) explain processes for refresh rates 4 and 2, respectively.

(A) Refresh rate=4

First, the formula (I) with k=0 is employed.
16=2⁴=(2²−1)×2²+2²×1
Then the clocks of diagram (a) are divided into four (2²=4) equal sub-cycles each having four (2²=4) clocks, as shown in diagram (c). The formula (II) is further employed to divide the nine “ON” clocks.
9=2×2²+1
Then each sub-cycle comprises two continuous “ON” clocks and two continuous “OFF” clocks; and the remainder, one “ON” clock, may be arranged at the last clock of the first sub-cycle, as shown with phantom line.
(B) Refresh rate=2

The diagram (d) shows a result of the diagram (a) processed with a frequency division factor 2, and each clock of the diagram (d) is defined as a bi-clock. The formula (I) is employed with k=1.
16=2⁴=(2²−1)×2¹×2¹+2¹×2¹
After dividing into two sub-cycles, each sub-cycle in the diagram (e) comprises four (2²=4) bi-clocks and eight clocks. Formula (II) is then employed to divide the nine “ON” clocks.
9=2×2¹×2¹+1
Then each sub-cycle is composed of two continuous “ON” bi-clocks and two continuous “OFF” bi-clocks; and the remainder, one “ON” clock, is also arranged at the last clock of the first sub-cycle, as shown in phantom line.

As illustrated in the above examples, continuous “OFF” clocks are consequently divided and approximately uniformly distributed in a PWM cycle, and therefore the LED will be lit more frequently without flickering. Particularly, the duty cycle is preserved as 9/16, so that brightness of the LED is the same for viewers.

Thus, generally the system described above for driving LED's in a display comprises an LED driving device, a PWM unit and an LED driving circuit, where in the LED driving device receives a preset value corresponding to a desired apparent brightness of the LED and delivers the preset value to the PWM unit, the PWM unit generates an ON/OFF signal with a duty cycle in a PWM cycle corresponding to the preset value and then modulating the ON/OFF signal, the modulated signal being output to the LED through the LED driving circuit to achieve desired apparent brightness. The PWM unit modulates the ON/OFF signal from one signal of higher gray-scale resolution to two or more signals of relatively lower gray-scale resolution, so that the LED will be lit more frequently with a higher refresh rate and intended brightness of the LED before modulation is matched by the apparent brightness after modulation. This system compensates for the flicker effect and the apparent reduction in brightness due to the flicker effect.

What is claimed is:

1. An LED driving device with PWM (pulse width modulation), comprising a PWM unit and an LED driving circuit, the LED driving device receiving a preset value about brightness of the LED and delivering the preset value to the PWM unit, the PWM unit generating an ON/OFF signal with a duty cycle in a PWM cycle corresponding to the preset value and then modulating the ON/OFF signal, the modulated signal being output to the LED through the LED driving circuit to perform desired brightness; wherein:
the PWM unit modulates the ON/OFF signal from one signal of higher gray-scale resolution to two or more signals of relatively lower gray-scale resolution, so that the LED will be lit more frequently with a higher refresh rate and brightness of the LED before and after modulation is exactly the same or similar to a viewer.

2. The LED driving device with PWM as claimed in claim 1, wherein the PWM cycle of the ON/OFF signal has a continuous “ON” duration composed of a major “ON” cycle and a minor “ON” cycle, and the PWM unit modulates the ON/OFF signal by dividing the major “ON” cycle into two or more parts each defined as a major “ON” sub-cycle, and distributing the major “ON” sub-cycles in the PWM cycle according to an algorithm.

3. The LED driving device with PWM as claimed in claim 2, wherein the PWM unit further divides the minor “ON” cycle into two or more parts each defined as a minor “ON” sub-cycle all of which are then distributed with the major “ON” sub-cycles.

4. The LED driving device with PWM as claimed in claim 2, wherein the major “ON” cycle is evenly divided and uniformly distributed.

5. The LED driving device with PWM as claimed in claim 1, wherein the modulated signal output from the PWM unit is clock-based.

6. The LED driving device with pulse width modulation as claimed in claim 2, wherein the PWM unit divides one PWM cycle having 2ⁿ clocks according to the formula (I):
2ⁿ⁼(2^{m}−1)×2^{k}×2^{n-m-k}+2^{k}×2^{n-m-k} (I)
wherein n is a positive integer, m is 0 or a positive integer less than n, k is 0 or a positive integer less than m;
accordingly, the PWM cycle may be divided either 2^{n-m-k}+1 sub-cycles composed of 2^{n-m-k} sub-cycles each having (2^{m}−1)×2^{k} clocks and one sub-cycle having 2^{k}×2^{n-m-k} clocks; or 2^{n-m-k} sub-cycles each having 2^{m}×2^{k} clocks; wherein 2^{k} is a frequency division factor.

7. The LED driving device with PWM as claimed in claim 2, wherein the PWM unit divides the continuous “ON” duration having M clocks in one PWM cycle according to formula (II):
M=A×2^{k}×2^{n-m-k}+B (II)
wherein n, m and k are defined as the above, M is a positive integer less than 2ⁿ, A is 0 or a positive less than M, B is 0 or a positive integer less than 2^{k}×2^{n-m-k};
accordingly, the major “ON” cycle has A×2^{k}×2^{n-m-k} clocks, and the minor “ON” cycle has B clocks; and M clocks are divided into either (2^{n-m-k}+1) sub-cycles composed of 2^{n-m-k} sub-cycles each having A×2^{k} clocks and one sub-cycle having B clocks; or 2^{n-m-k} sub-cycles each having (A×2^{k}+i) clocks;
wherein i is 0 or a positive integer equal to or less than 2^{k}, and a sum of i from each sub-cycle is equal to B

[symbol]

8. The LED driving device with PWM as claimed in claim 2, wherein the PWM unit divides one PWM cycle having 2ⁿ clocks with M “ON” clocks as follows:
a. dividing the PWM cycle into (2^{n-m-k}+1) sub-cycles composed of 2^{n-m-k} sub-cycles each having (2^{m}−1)×2^{k} clocks with A×2^{k} “ON” clocks, and one sub-cycle having 2^{k}×2^{n-m-k} clocks with B “ON” clocks; or
b. dividing the PWM cycle into 2^{n-m-k} sub-cycles each having 2^{m}×2^{k} clocks with (A×2^{k}+i) “ON” clocks;
wherein n, m, k, M, A, B and i are defined as the above.

9. The LED driving device with PWM as claimed in claim 1, wherein the duty cycle of the ON/OFF signal is preserved before and after modulation.
